(19) United States
(12) Patent Application Publication
(10) Pub. No.: US 2018/0033178 A1
(43) Pub. Date: Feb. 1, 2018

(54) Method of Augmenting a Geospatially-Accurate Virtual Reality with Annotations

(71) Applicant: Vernon Dwain Hutchins, Carencro, LA (US)

(72) Inventor: Vernon Dwain Hutchins, Carencro, LA (US)

(21) Appl. No.: 15/666,559

(22) Filed: Aug. 1, 2017

Related U.S. Application Data
(60) Provisional application No. 62/369,272, filed on Aug. 1, 2016.

(51) Int. Cl. G06T 11/60; G06F 3/0482; G06F 3/0488; G06F 17/30; G06F 21/62

(52) U.S. Cl. CPC G06T 11/60; G06F 17/3087; G06F 17/30241; G06F 21/6218; G06F 3/0488; G06F 3/0482; G06F 3/04886

(57) ABSTRACT

Disclosed is a method of augmenting a geospatially-accurate virtual reality with annotations.

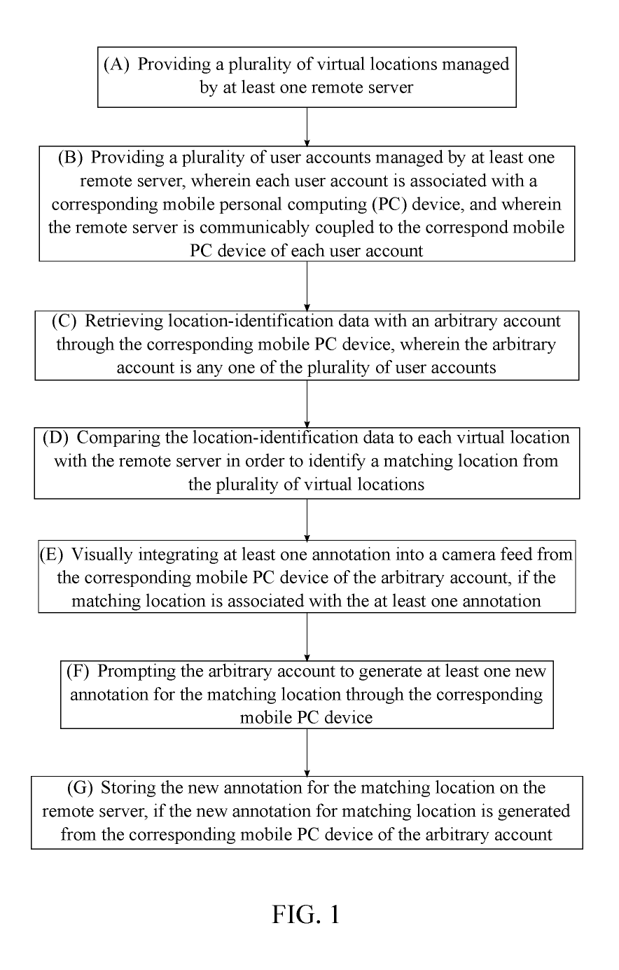

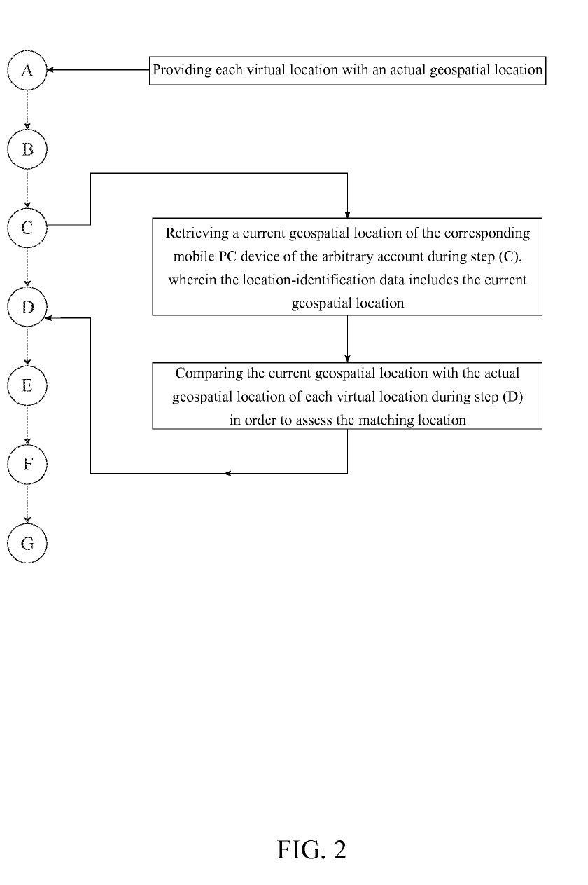

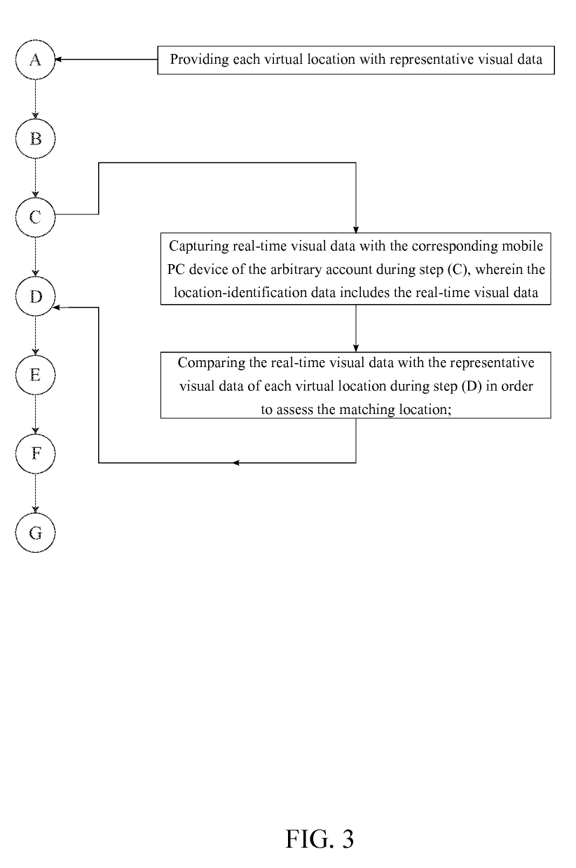

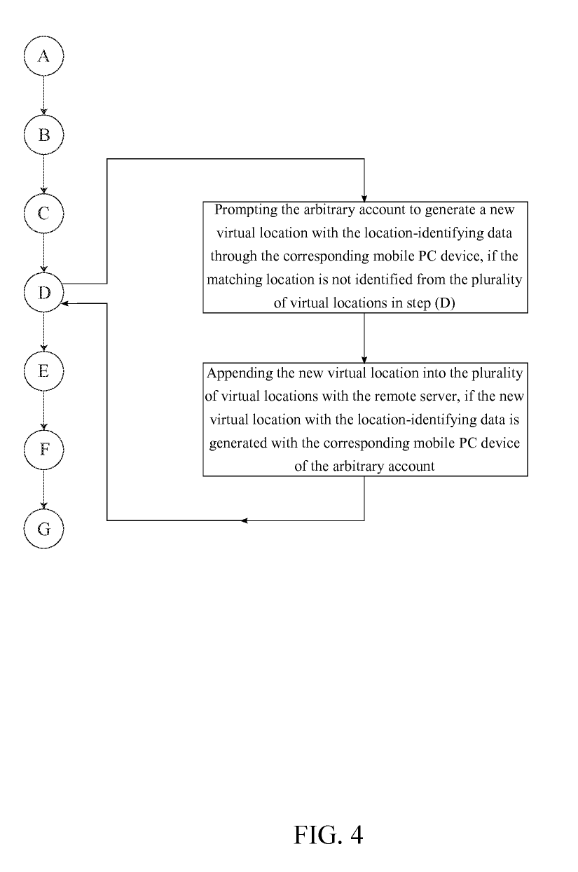

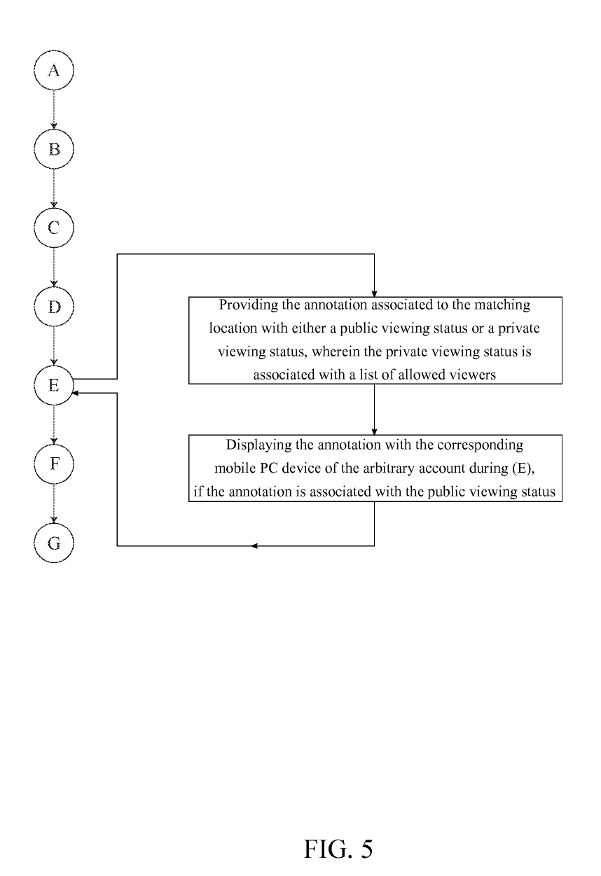

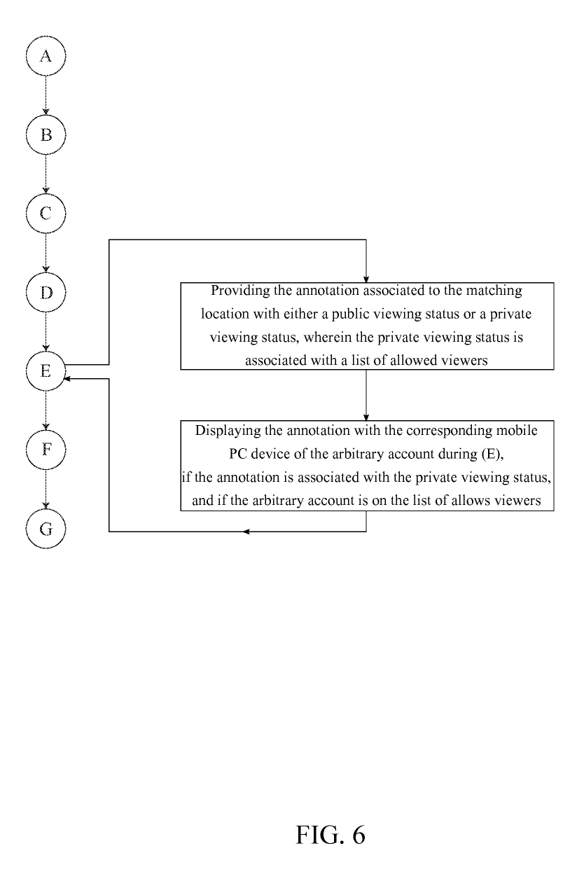

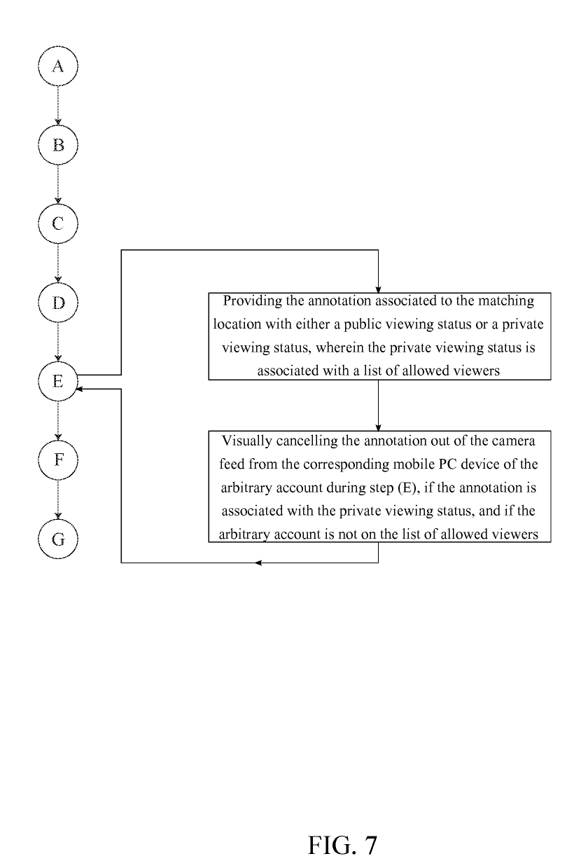

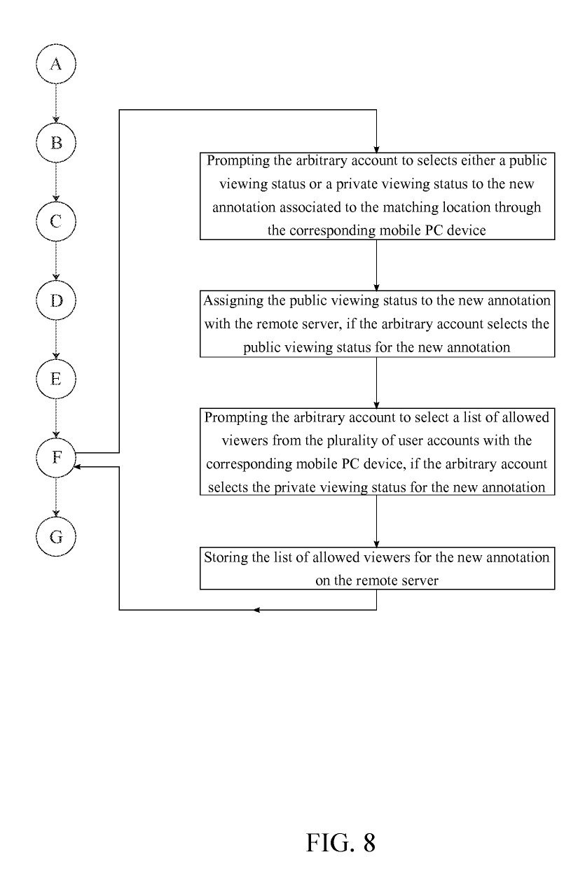

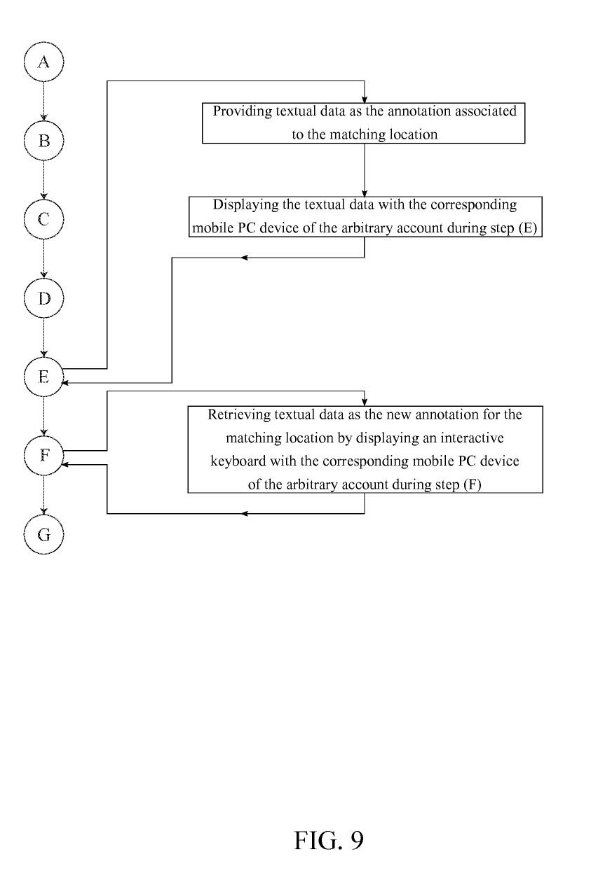

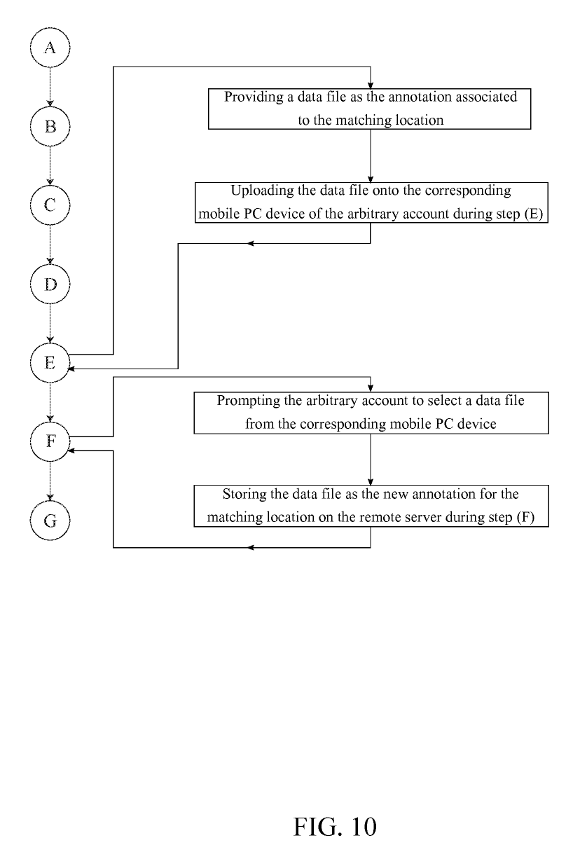

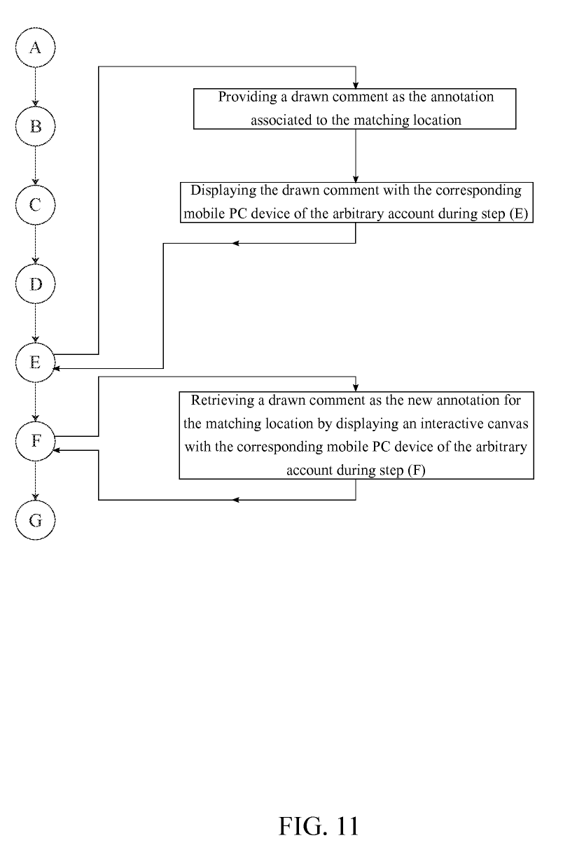

The current application claims a priority to the U.S. Provisional Patent application Ser. No. 62/369,272 filed on Aug. 1, 2016.

### FIELD OF THE INVENTION

The present invention generally relates to a method and system for implementing an augmented reality with annotations. More specifically, the present invention manages a geospatially-accurate virtual world that allows different user to make annotations at specific locations in the geospatially-accurate virtual world.

### BACKGROUND OF THE INVENTION

Every day, millions of people utilize smart-phones and mobile devices. Mobile devices have become a part of the daily activity of many people. Therefore, the objective of the present invention to provide a method and a system to manage and to annotate a geospatially-accurate virtual world. Another objective of the present invention is to share those annotation amongst its users and consequently allows those users to communicate with each other.

### SUMMARY OF THE INVENTION

Utilizing the present invention when the user's friends having the same software application allows the user, at any location, to use the camera on his/her mobile device to view the area around the user. The user's friends can leave messages and files in specific areas. For example, if the user were to visit a friend's house, then the user could virtually leave a file behind the couch for another user. The user will have to have permission to look at the file or be friends with that person however he/she wants it shared.

The present invention could also be used to create mark things and make notes on them if the user is driving down the road. If the user's friend made marks, he/she can follow the marks to the location where the user is going. Holding the camera, the user can view whatever is noted e.g. use that door, watch your step, for contractors could leave notes on the building change this etch.

When in record mode, the user can walk with the phone or smart device with the software application running and when panning the device, the user can utilize his/her finger on the touchscreen to draw and make changes to the scene. When another person comes and is also using the present invention, the other can view whatever was noted and left for the initial person.

The present invention has many uses; from emergency to police using the present invention as a means of alerting or notifying. Someone can leave notes for the police to go in a specific area and when the police view it, they can get the notes and drawings left and much more.

### BRIEF DESCRIPTION OF THE DRAWINGS

FIGURES illustrate the present invention.

### DETAILED DESCRIPTION OF THE INVENTION

All illustrations of the drawings are for the purpose of describing selected versions of the present invention and are not intended to limit the scope of the present invention.

The present invention is a method of augmenting a geospatially-accurate virtual reality with annotations, which allows different users to find those annotations at specific geospatial locations with their mobile personal computing (PC) device. The system used to implement the method of the present invention includes at least one remote server, which manages a plurality of virtual locations (Step A). These virtual locations provide the remote server with a reference to identify a physical location as a user enters the physical location. In addition, the remote server is used to manage the interactions amongst a plurality of user accounts (Step B), each of which allows the remote server to uniquely identify a single user. Each user account also allows a user to interact with the functionalities of the present invention. In addition, each user account is associated with a corresponding mobile PC device that is communicably coupled to the remote server. This allows different users to interact with each other and with the remote server with their mobile PC device. Moreover, the corresponding mobile PC device is preferably a smart phone, a tablet PC device, or a laptop.

The method of the present invention follows an overall process so that any user is able annotate any of the plurality of virtual locations, which can also be accessed and viewed by any user. The overall process begins by retrieving location-identification data through the corresponding mobile PC device of an arbitrary account (Step C), which can be any one of the plurality of user accounts. The location-identification data is preferably photographs, video, or global positioning system (GPS) data that can be used to identify the physical location of the corresponding mobile PC device. The overall process continues by comparing the location-identification data to each virtual location with the remote server in order to identify a matching location from the plurality of virtual locations (Step D). The matching location has virtual attributes that closely match the actual attributes from the location-identification data. For example, if the location-identification data includes a picture of the Colosseum and a set of GPS coordinates that say somewhere in Italy, the remote server would recognize the matching location as Rome because the virtual location of Rome stored on the remote server would also have a digital visual of the Colosseum and the set of GPS coordinates for Rome. Moreover, if the matching location is associated with the at least one annotation, the overall process proceeds by visually integrating at least one annotation into a camera feed from the corresponding mobile PC device (Step E). The camera feed is the live visual feed that is captured and redisplayed through the corresponding mobile PC device. The camera feed is then augmented by the annotation associated with the matching location. The annotation can be any kind of visual or written comment to the matching location. For example, the annotation can be a red circle that is outlining a particular feature on the Colosseum as the Colosseum is viewed through the camera feed of the corresponding mobile PC device.

The overall process continues by prompting the arbitrary account to generate at least one new annotation for the matching location through the corresponding mobile device (Step F). The new annotation is a visual or written comment made by the arbitrary account on the matching location. For example, if a user of the arbitrary account notices an interesting feature on the Colosseum, then the user of the arbitrary account can make a visual or written comment on the interesting feature through the present invention. In addition, the remote server needs to store the new annotation for the matching location (Step G), if the new annotation of the matching location is generated from the corresponding mobile PC device of the arbitrary account. This allows future users that are visiting the matching location to view the new annotation created by the user of the arbitrary account.

The present invention executes one of the two following sub-processes or a combination of the following sub-processes in order to accurately identify the matching location. The first sub-process provides each virtual location with an actual geospatial location, which is preferable a set of GPS coordinates. The first sub-process specifies Step C to be retrieving a current geospatial location of the corresponding mobile PC device of the arbitrary account. The current geospatial location is either determined by a GPS module within the correspond mobile PC device or retrieved from an information network (e.g. the Internet). For the first sub-process, the current geospatial location is included as a piece of the location-identifying data. The first sub-process continues by specifying Step D to be comparing the current geospatial location with the actual geospatial location of each virtual location in order to assess the matching location. Thus, for the first sub-process, the remote server is able to assess the matching location by analyzing the geospatial location of the corresponding mobile PC device of the arbitrary account.

Moreover, the second sub-process provides each virtual location with representative visual data, which can be photographs or videos of the physical location. The second sub-process specifies Step C to be capturing real-time visual data with the corresponding mobile PC device of the arbitrary account. The real-time visual data is the visual data captured by the camera feed, which again can be photographs or video. For the second sub-process, the real-time visual data is included as a piece of the location-identifying data. The second sub-process continues by specifying Step D to be comparing the real-time visual data with the representative visual data of each virtual location during in order to assess the matching location. Thus, for the second sub-process, the remote server is able to assess the matching location by analyzing visual similarities between the physical location and a virtual location. In addition, the first sub-process and the second sub-process can be used in combination to search for the matching location. Alternatively, the first sub-process can be used to narrow the search for the matching location, and then the second sub-process can be used to further narrow and complete the search for the matching location, or vice versa.

As the present invention become more widespread, users of the present invention will regularly gather at popular locations. The present invention allows for a user to store the popular location as a virtual location on the remote server. Thus, the present invention is able to prompt the arbitrary user to generate a new virtual location with the location-identifying data through the corresponding mobile PC device. This only occurs if the matching location is not identified from the plurality of virtual locations during Step D. Once the user of the arbitrary account generates the new virtual location with the location-identifying data with the corresponding mobile PC device, the remote server appends the new virtual location into the plurality of virtual locations. For example, if the user of the arbitrary account enters the Lost City of Atlantis, and if the remote server is not able to identify the Lost City of Atlantis amongst the plurality of virtual locations, then the remote server uses the location-identifying data gathered by the corresponding mobile PC device and adds a new virtual location to the plurality of virtual locations.

The present invention also enables users to implement permission settings for their annotations. Thus, the present invention provides the annotation associated to the matching location with either a public viewing status or a private viewing status. The public viewing status permits the user for any of the plurality of user accounts to see the annotation. The private viewing status permits only users on list of allowed viewers to see the annotation. Consequently, Step E can vary with three different outcomes. The first outcome is that if the annotation has a public viewing status, then the annotation is displayed with the corresponding mobile PC device of the arbitrary account. The second outcome is that if the annotation has a private viewing status and if the arbitrary account is on the list of allowed viewers, then the annotation is displayed with the corresponding mobile PC device of the arbitrary account. The third outcome is that if the annotation has a private viewing status and if the arbitrary account is not on the list of allowed viewers, then the annotation is visually eliminated out of the camera feed from the correspond mobile PC device of the arbitrary account.

Likewise, the present invention allows the user of the arbitrary account to set the permission setting for the new annotation for the matching location. The present invention begins by prompting the arbitrary account to select either a public viewing status or a private viewing status to the new annotation associated to the matching location through the corresponding mobile PC device. If the arbitrary account selects a public viewing status for new annotation, then the remote server assigns the public viewing status to the new annotation. However, if the arbitrary account selects a public viewing status for new annotation, then the present invention prompts the arbitrary account to select a list of allowed viewers from the plurality of user accounts with the corresponding mobile PC device. The list of allowed viewers should include anyone that is specified by the user of the arbitrary account. Once the list of allowed viewers for is selected by the user of the arbitrary account, the list of allowed viewers for the new annotation is stored on the remote server for future reference.

Annotations for the present invention can be derived from a variety of sources. One such source provides textual data as the annotation associated to the matching location. For example, the textual data could be a warning such as “Do not touch the water” or an unnoticeable detail such as “The pink sand comes from granulated seashells”. Thus, the present invention allows the textual data to be displayed with the corresponding mobile PC device to the user of the arbitrary account during Step E. Another source provides a data file as the annotation associated to the matching location. For example, the data file could be a set of rules of what kinds of fishes can or cannot be caught at a specific lake. Thus, the present invention allows the data file to be uploaded onto the corresponding mobile PC device of the arbitrary account during Step E. Another source is a drawn comment as the annotation associated to the matching location. For example, the drawn comment could be a set of arrows pointed to various bird nests that mounted at different spots along a line of trees. Thus, the present invention allows the drawn comment to be displayed with the corresponding mobile PC device to the user of the arbitrary account during Step E.

Likewise, the present invention provides the means to generate different kinds of annotations. One means for the present invention is to retrieve textual data as the new annotation for the matching location by displaying an interactive keyboard with the corresponding mobile PC device of the arbitrary account during Step F. The interactive keyboard allows the user of the arbitrary account to input and format any kind of text. Another means for the present invention is to prompt the arbitrary account to select a data file from the corresponding mobile PC device and to then store the data file as the new annotation for the matching location on the remote server for future reference and extraction during Step F. Another means for the present invention is to retrieve a drawn comment as the new annotation for the matching location by displaying an interactive canvas with the corresponding mobile PC device of the arbitrary account during Step F. The interactive canvas allows the user of the arbitrary account to input and format any kind of drawing.

Although the invention has been explained in relation to its preferred embodiment, it is to be understood that many other possible modifications and variations can be made without departing from the spirit and scope of the invention as hereinafter claimed.

What is claimed is:

1. A method of augmenting a geospatially-accurate virtual reality with annotations, the method comprises the steps of:
(A) providing a plurality of virtual locations managed by at least one remote server;
(B) providing a plurality of user accounts managed by at least one remote server, wherein each user account is associated with a corresponding mobile personal computing (PC) device, and wherein the remote server is communicably coupled to the corresponding mobile PC device of each user account;
(C) retrieving location-identification data through the corresponding mobile PC device of an arbitrary account, wherein the arbitrary account is any one of the plurality of user accounts;
(D) comparing the location-identification data to each virtual location with the remote server in order to identify a matching location from the plurality of virtual locations;
(E) visually integrating at least one annotation into a camera feed from the corresponding mobile PC device of the arbitrary account, if the matching location is associated with the at least one annotation;
(F) prompting the arbitrary account to generate at least one new annotation for the matching location through the corresponding mobile PC device; and
(G) storing the new annotation for the matching location on the remote server, if the new annotation for matching location is generated from the corresponding mobile PC device of the arbitrary account.

2. The method of augmenting a geospatially-accurate virtual reality with annotations, the method as claimed in claim 1 comprises the steps of:
providing each virtual location with an actual geospatial location;
retrieving a current geospatial location of the corresponding mobile PC device of the arbitrary account during step (C), wherein the location-identification data includes the current geospatial location; and
comparing the current geospatial location with the actual geospatial location of each virtual location during step (D) in order to assess the matching location.

3. The method of augmenting a geospatially-accurate virtual reality with annotations, the method as claimed in claim 1 comprises the steps of:
providing each virtual location with representative visual data;
capturing real-time visual data with the corresponding mobile PC device of the arbitrary account during step (C), wherein the location-identification data includes the real-time visual data; and
comparing the real-time visual data with the representative visual data of each virtual location during step (D) in order to assess the matching location.

4. The method of augmenting a geospatially-accurate virtual reality with annotations, the method as claimed in claim 1 comprises the steps of:
prompting the arbitrary account to generate a new virtual location with the location-identifying data through the corresponding mobile PC device, if the matching location is not identified from the plurality of virtual locations in step (D); and
appending the new virtual location into the plurality of virtual locations with the remote server, if the new virtual location with the location-identifying data is generated with the corresponding mobile PC device of the arbitrary account.

5. The method of augmenting a geospatially-accurate virtual reality with annotations, the method as claimed in claim 1 comprises the steps of:
providing the annotation associated to the matching location with either a public viewing status or a private viewing status, wherein the private viewing status is associated with a list of allowed viewers; and
displaying the annotation with the corresponding mobile PC device of the arbitrary account during (E),
if the annotation is associated with the public viewing status.

6. The method of augmenting a geospatially-accurate virtual reality with annotations, the method as claimed in claim 1 comprises the steps of:
providing the annotation associated to the matching location with either a public viewing status or a private viewing status, wherein the private viewing status is associated with a list of allowed viewers; and
displaying the annotation with the corresponding mobile PC device of the arbitrary account during (E),
if the annotation is associated with the private viewing status,
and if the arbitrary account is on the list of allowed viewers.

7. The method of augmenting a geospatially-accurate virtual reality with annotations, the method as claimed in claim 1 comprises the steps of:
providing the annotation associated to the matching location with either a public viewing status or a private viewing status, wherein the private viewing status is associated with a list of allowed viewers; and
visually eliminating the annotation out of the camera feed from the corresponding mobile PC device of the arbitrary account during step (E),
if the annotation is associated with the private viewing status,
and if the arbitrary account is not on the list of allowed viewers.

8. The method of augmenting a geospatially-accurate virtual reality with annotations, the method as claimed in claim 1 comprises the steps of:
prompting the arbitrary account to select either a public viewing status or a private viewing status to the new annotation associated to the matching location through the corresponding mobile PC device during step (F);
assigning the public viewing status to the new annotation with the remote server, if the arbitrary account selects the public viewing status for the new annotation;
prompting the arbitrary account to select a list of allowed viewers from the plurality of user accounts with the corresponding mobile PC device,
if the arbitrary account selects the private viewing status for the new annotation; and
storing the list of allowed viewers for the new annotation on the remote server.

9. The method of augmenting a geospatially-accurate virtual reality with annotations, the method as claimed in claim 1 comprises the steps of:
providing textual data as the annotation associated to the matching location; and
displaying the textual data with the corresponding mobile PC device of the arbitrary account during step (E).

10. The method of augmenting a geospatially-accurate virtual reality with annotations, the method as claimed in claim 1 comprises the step of:
retrieving textual data as the new annotation for the matching location by displaying an interactive keyboard with the corresponding mobile PC device of the arbitrary account during step (F).

11. The method of augmenting a geospatially-accurate virtual reality with annotations, the method as claimed in claim 1 comprises the steps of:
providing a data file as the annotation associated to the matching location; and
uploading the data file onto the corresponding mobile PC device of the arbitrary account during step (E).

12. The method of augmenting a geospatially-accurate virtual reality with annotations, the method as claimed in claim 1 comprises the steps of:
prompting the arbitrary account to select a data file from the corresponding mobile PC device; and
storing the data file as the new annotation for the matching location on the remote server during step (F).

13. The method of augmenting a geospatially-accurate virtual reality with annotations, the method as claimed in claim 1 comprises the steps of:
providing a drawn comment as the annotation associated to the matching location; and
displaying the drawn comment with the corresponding mobile PC device of the arbitrary account during step (E).

14. The method of augmenting a geospatially-accurate virtual reality with annotations, the method as claimed in claim 1 comprises the step of:
retrieving a drawn comment as the new annotation for the matching location by displaying an interactive canvas with the corresponding mobile PC device of the arbitrary account during step (F).
